(19) United States
(12) Patent Application Publication
(10) Pub. No.: US 2019/0309710 A1
(43) Pub. Date: Oct. 10, 2019

(54) AIR FILTER HOUSING WITH DISCRETE MOUNTING FEATURE

(71) Applicant: FORD GLOBAL TECHNOLOGIES, LLC, Dearborn, MI (US)

(72) Inventors: Jeff Sean Boulton, Monroe, MI (US); Roger Joseph Khami, Troy, MI (US); Dennis Davies, White Lake, MI (US); David Lowrie, Windsor (CA); James Labadie, Dexter, MI (US); Preet Kamal Virk, Canton, MI (US)

(21) Appl. No.: 15/945,233

(22) Filed: Apr. 4, 2018

(51) Int. Cl. F02M 35/024; B60K 13/02; B01D 46/00

(52) U.S. Cl. CPC F02M 35/02416; B01D 2279/60; B01D 46/0002; B60K 13/02

(57) ABSTRACT

An apparatus is provided including an air filter housing, a receiver on the air filter housing and a discrete mounting feature secured to the air filter housing at the receiver.

### TECHNICAL FIELD

This document relates generally to the motor vehicle equipment field and, more particularly, to an apparatus in the form of an air filter housing that incorporates a discrete mounting feature.

### BACKGROUND

An engine air induction system filter enclosure is mounted to either the engine/power train or the vehicle structure. It is desired that the mounting feature for the filter enclosure be exterior to the filter enclosure so that the subassembly can be installed as a closed unit.

Typical mounting features in the prior art include tapered mounting pins and isolator grommets, metal compression limiting sleeves and threaded fasteners. The mounting pins in the prior art devices are integrally molded to the exterior of the engine filter box or air filter housing. In certain applications such a structure cannot be produced by simple and inexpensive injection molding techniques.

This document relates to a new and improved apparatus comprising an air filter housing and a discrete mounting feature that is secured to the air filter housing. For many applications such a structure is less expensive to produce and easy to assemble thereby providing valuable benefits.

### SUMMARY

In accordance with the purposes and benefits described herein, a new and improved apparatus is provided. That apparatus comprises an air filter housing, a receiver on the air filter housing and a discrete mounting feature that is secured to the air filter housing at the receiver.

The receiver may comprise a filter housing margin surrounding a mounting aperture. Further, the receiver may include a plurality of insert notches in communication with the mounting aperture.

The discrete mounting feature may include a pilot ring received in the mounting aperture. That pilot ring may include a plurality of retaining tabs radially arrayed around the pilot ring.

The air filter housing margin may include a plurality of arc segments extending between the plurality of insert notches. Each arc segment of the plurality of arc segments may include a catch at a first end and a stop at a second end. The catch may include a ramp adjacent one insert notch of the plurality of insert notches and a shoulder opposite the ramp oriented toward the stop.

The discrete mounting feature may include a mounting flange. The mounting flange, the pilot ring and the plurality of retaining tabs may define a plurality of channels that receive the plurality of arc segments when the plurality of retaining tabs are secured in a juxtaposed, overlapping relationship with the plurality of arc segments between the catch and the stop on each of the arc segments.

The discrete mounting feature may also include a tapered mounting pin (could be straight/cylindrical). The tapered mounting pin may include an integral drive feature. The tapered mounting pin may include a first frustoconical section and a second frustoconical section. The tapered mounting pin may include a locking ring. The tapered mounting pin may include a cylindrical section.

The integral drive feature, the locking ring and the cylindrical section may be positioned between the first frustoconical section and the second frustoconical section. The locking ring may be provided between the cylindrical section and the integral drive section. The integral drive feature may include six facets.

In the following description, there are shown and described several preferred embodiments of the apparatus. As it should be realized, the apparatus is capable of other, different embodiments and its several details are capable of modification in various, obvious aspects all without departing from the apparatus as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and together with the description serve to explain certain principles thereof.

FIG. 1 is a side elevational view of the discrete mounting feature of the apparatus.

FIG. 2 is a perspective view of the filter housing mounting side of the discrete mounting feature that is secured to the receiver on the air filter housing.

FIG. 3a is a detailed internal view of the receiver in the air filter housing.

FIG. 3b is a detailed external view of the receiver in the air filter housing.

FIGS. 4a-4c are a series of perspective views illustrating how the discrete mounting feature is secured in the receiver of the air filter housing.

FIG. 4a illustrates insertion of the filter housing mounting side of the discrete mounting feature in the receiver of the air filter housing.

FIG. 4b illustrates the discrete mounting feature fully inserted into the receiver of the air filter housing prior to twisting.

FIG. 4c illustrates the discrete mounting feature fully secured in the receiver of the air filter housing following twisting.

FIG. 5a is a perspective view illustrating the mounting of the air filter housing on a support bracket by means of the tapered mounting pin of the discrete mounting feature.

FIG. 5b is a cross-sectional view of the structure illustrated in FIG. 5a.

FIG. 6 illustrates an alternative embodiment of the discrete mounting feature incorporating a snap attachment feature instead of the twist feature illustrated in FIGS. 1, 2 and 4a-4c.

FIG. 7 is a detailed cross-sectional view illustrating how the alternative embodiment of the discrete mounting feature incorporating the snap attachment feature is secured at the receiver in the air filter housing.

Reference will now be made in detail to the present preferred embodiments of the apparatus, examples of which are illustrated in the accompanying drawing figures.

### DETAILED DESCRIPTION

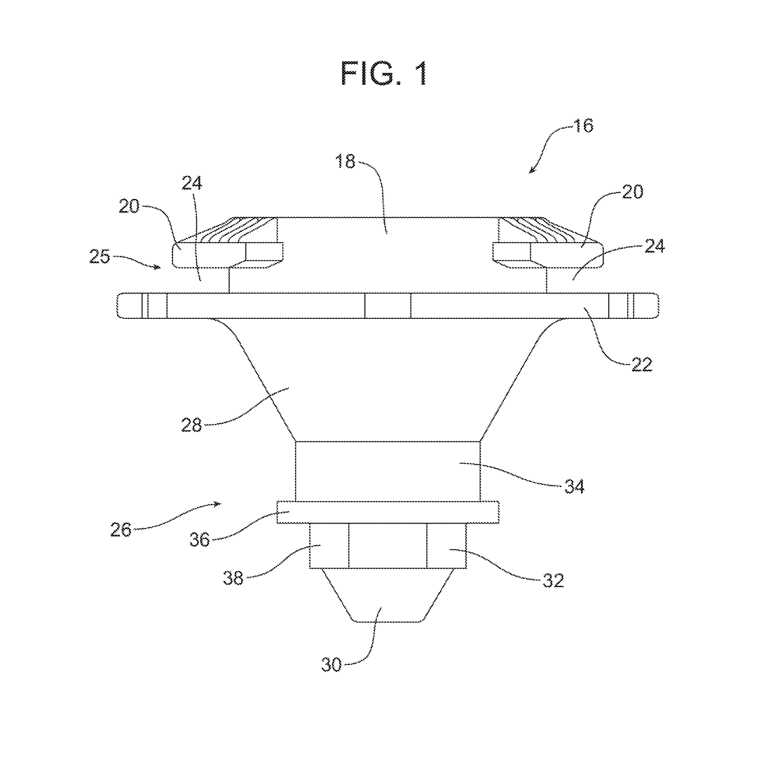

Reference is now made to drawing FIGS. 1, 2, 3a, 3b, 4a-4c, 5a and 5b illustrating the new and improved apparatus 10. That apparatus 10 includes an air filter housing 12 having a receiver 14 and a discrete mounting feature 16 that is secured to the air filter housing at the receiver.

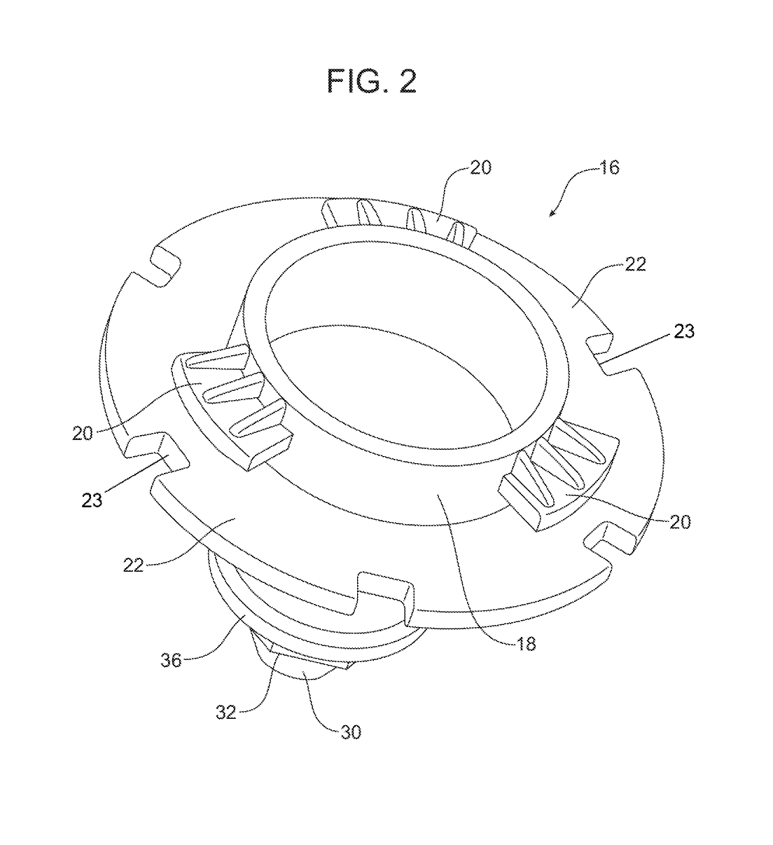

The discrete mounting feature 16 is best illustrated in FIGS. 1 and 2. The discrete mounting feature 16 may be a one-piece structure molded, formed, 3D printed, cast, sintered, or machined from filled or not filled resin such as polypropylene (PP), polyamide (PA), polyoxymethylene (acetal) (POM), polybutylene terephthalate (PBT), metallic or other appropriate material. In the illustrated embodiment, the discrete mounting feature 16 includes a pilot ring 18 that is adapted to be inserted into and received in the receiver 14 of the air filter housing 12. A plurality of retaining tabs 20 are radially arrayed around the pilot ring 18. In the illustrated embodiment, the discrete mounting feature 16 includes three retaining tabs 20.

The discrete mounting feature 16 further includes a mounting flange 22 spaced from the retaining tabs 20. In the illustrated embodiment, each of the retaining tabs 20 extends through an arc of approximately 40 degrees within a first plane P₁. In other embodiments, the retaining tabs 20 extend through an arc of as little as 20 degrees or as much as 90 degrees depending upon the number of tabs provided. In contrast, the mounting flange 22 extends 360 degrees around the discrete mounting feature 16 in a second plane P₂ substantially parallel to the first plane P₁. Three channels 24 are defined between the pilot ring 18, the three retaining tabs 20 and the mounting flange 22.

The pilot ring 18 and the retaining tabs 20 are provided on the filter housing mounting side 25 of the mounting flange 22. The discrete mounting feature 16 includes a tapered mounting pin 26 on the opposite side of the mounting flange 22. That tapered mounting pin 26 includes a first frustoconical section 28 depending from the mounting flange 22. The distal end of the tapered mounting pin 26 includes a second frustoconical section 30. An integral drive feature 32, a cylindrical section 34 and a locking ring 36 are provided between the first frustoconical section 28 and the second frustoconical section 30. In the illustrated embodiment, the locking ring 36 is provided between the cylindrical section 34 and the integral drive feature 32. The integral drive feature of the illustrated embodiment includes six facets 38 forming a nut shape that is easily gripped with a wrench, socket or other driving tool. The integral drive feature could include less than or more than six facets.

Notched integral drive features 23 may also be located on the external circumference of the mounting flange 22. (See FIG. 2). These may also be engaged by a tool when fastening the discrete mounting feature 16 to the air filter housing 12.

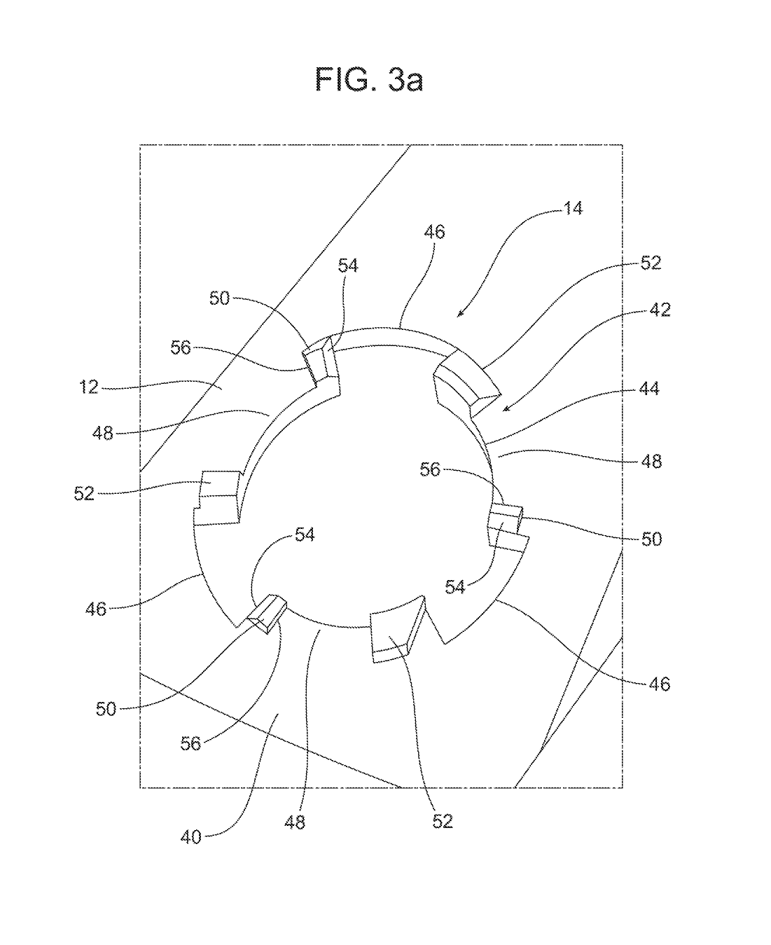

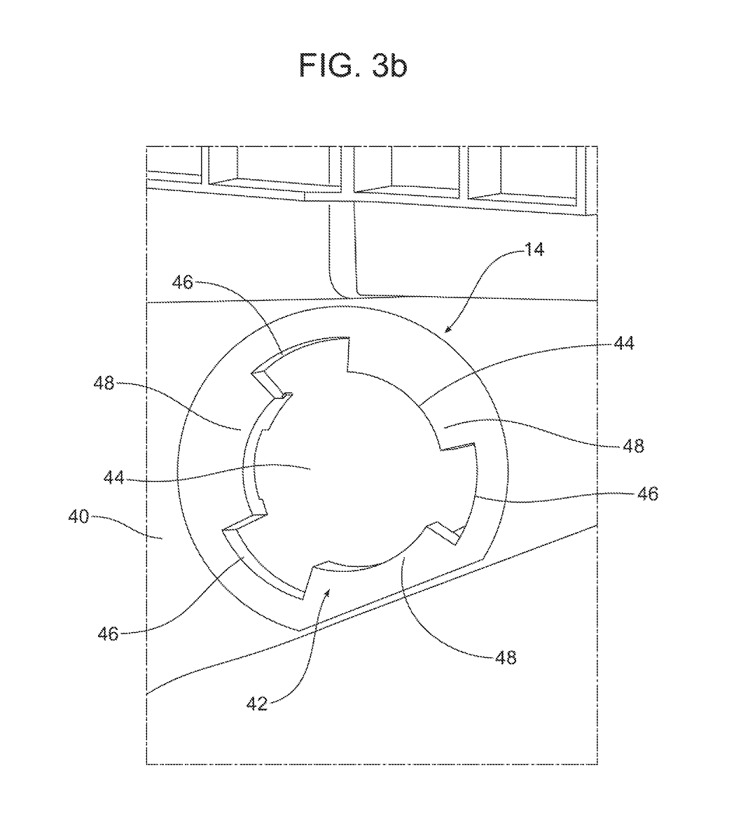

Reference is now made to FIGS. 3a and 3b illustrating the receiver 14 in the wall 40 of the air filter housing 12. In the illustrated embodiment, the receiver 14 comprises a filter housing margin 42 surrounding a mounting aperture 44. A plurality of insert notches 46 communicate with the mounting aperture 44. As a result, the air filter housing margin 42 includes a plurality of arc segments 48 extending between the plurality of insert notches. In the illustrated embodiment, the receiver 14 includes three insert notches 46 corresponding in size, shape and number to the three retaining tabs 20 on the discrete mounting feature 16.

As best illustrated in FIG. 3a, the receiver 14 of the illustrated embodiment includes three arc segments 48. Each arc segment 48 includes a catch 50 at a first end and a stop 52 at a second end. Each catch 50 includes a ramp 54 adjacent one insert notch 46 and a shoulder 56 opposite the ramp. That shoulder 56 is oriented toward the stop 52 provided on that same arc segment 48.

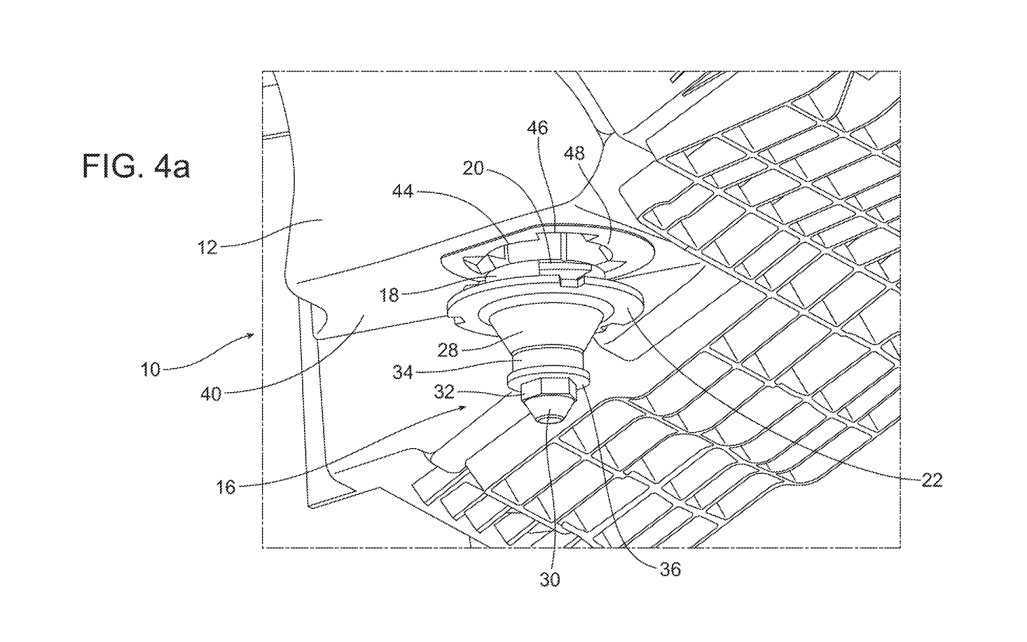

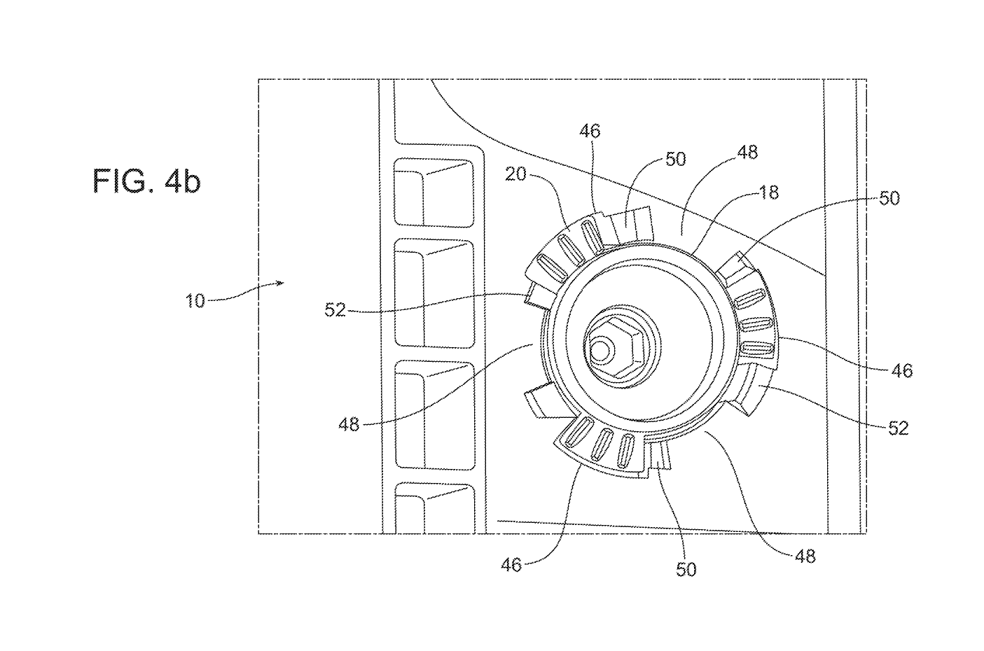

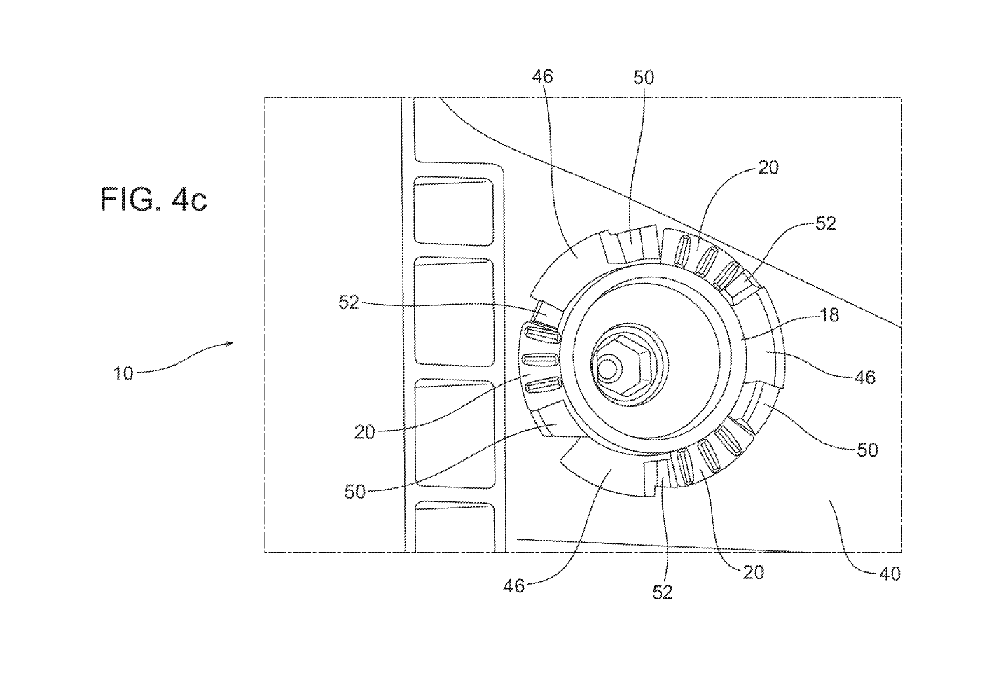

Reference is now made to FIGS. 4a-4c illustrating how the discrete mounting feature 16 is secured to the air filter housing 12 at the receiver 14. As illustrated in FIG. 4a, the filter housing mounting side 25 of the discrete mounting feature 16 is aligned with the receiver 14 in a position where the pilot ring 18 may be inserted in the direction of action arrow A into the mounting aperture 44. Toward this end, the retaining tabs 20 on the discrete mounting feature 16 are also aligned with the insert notches 46 of the receiver 14. Here it should be noted that those insert notches 46 are large enough to allow the passage of the retaining tabs 20 when the discrete mounting end of the discrete mounting feature 16 is inserted into the receiver 14. FIG. 4b illustrates the discrete mounting feature 16 when it is first fully inserted into the receiver 14 prior to twisting.

The discrete mounting feature 16 is locked in place in the receiver 14 of the air filter housing 12 by twisting in the direction of action arrow B. This is done by engaging the integral drive feature 32 with an appropriate drive tool. As the discrete mounting feature 16 is twisted, the retaining tabs 20 engage the ramps 54 which allow the tabs to pass over the catches 50. The discrete mounting feature 16 is twisted sufficiently to displace the retaining tabs 20 completely past the catches 50 so that each retaining tab is captured between the shoulder 56 of the associated catch at one end and the stop 52 at the other end. The arc segments 48 are simultaneously received in the plurality of channels 24 formed by the pilot ring 18, retaining tabs 20 and mounting flange 22 of the discrete mounting feature 16. Thus, it should be appreciated that the retaining tabs 20 are secured in a juxtaposed, overlapping relationship with the plurality of arc segments 48 between the catches 50 and the stops 52. This secures the discrete mounting feature 16 securely to the air filter housing 12 at the receiver 14.

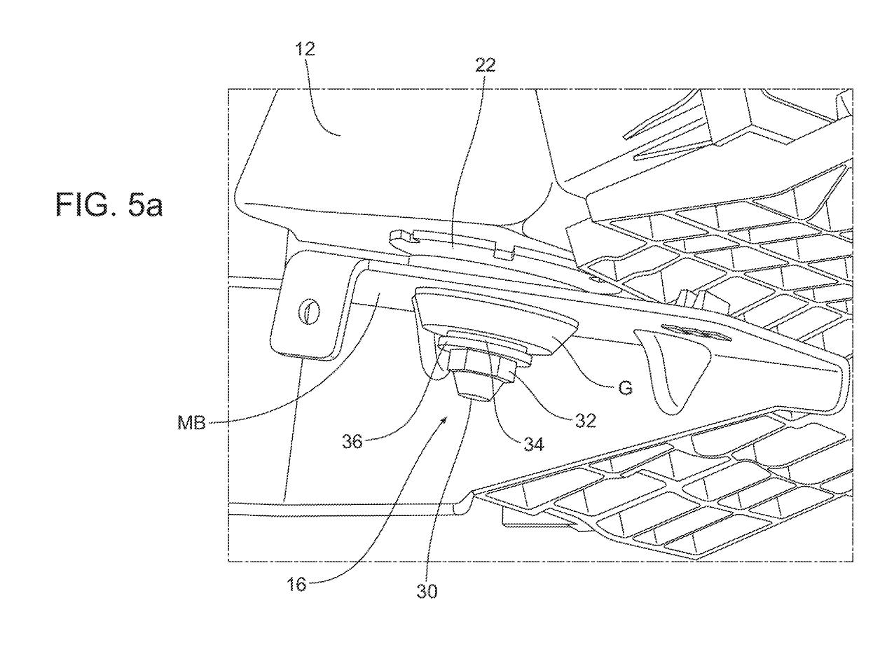

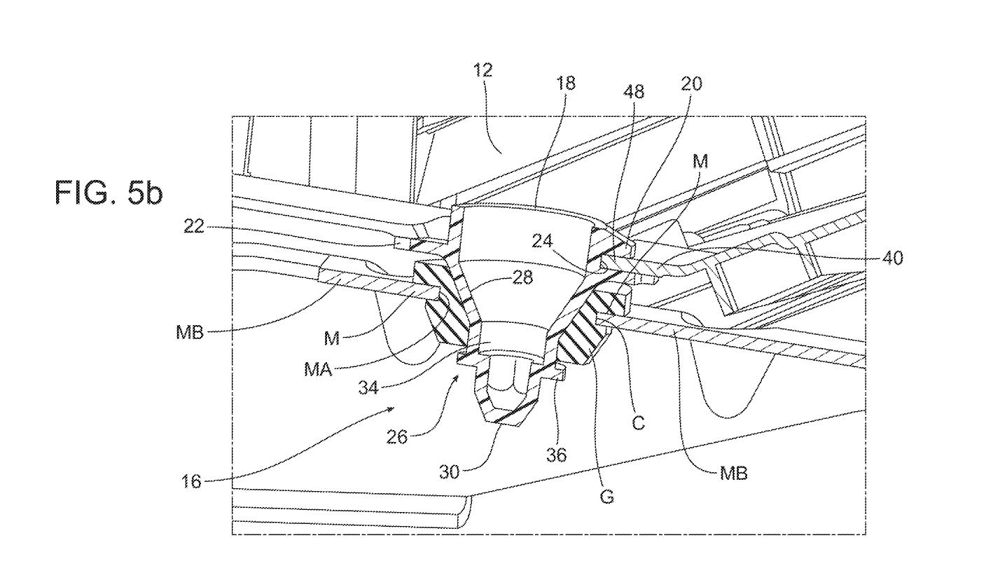

Reference is now made to FIGS. 5a and 5b illustrating how the apparatus 10 may be secured to a mounting bracket MB by means of the discrete mounting feature 16 secured in place in the receiver 14 on the air filter housing 12. More particularly, a rubber isolator grommet G is secured on the mounting feature 16 between the mounting flange 22 and the locking ring 36. The rubber grommet G includes a channel C that engages the margin M of the mounting bracket MB around the mounting aperture MA that receives the tapered mounting pin 26.

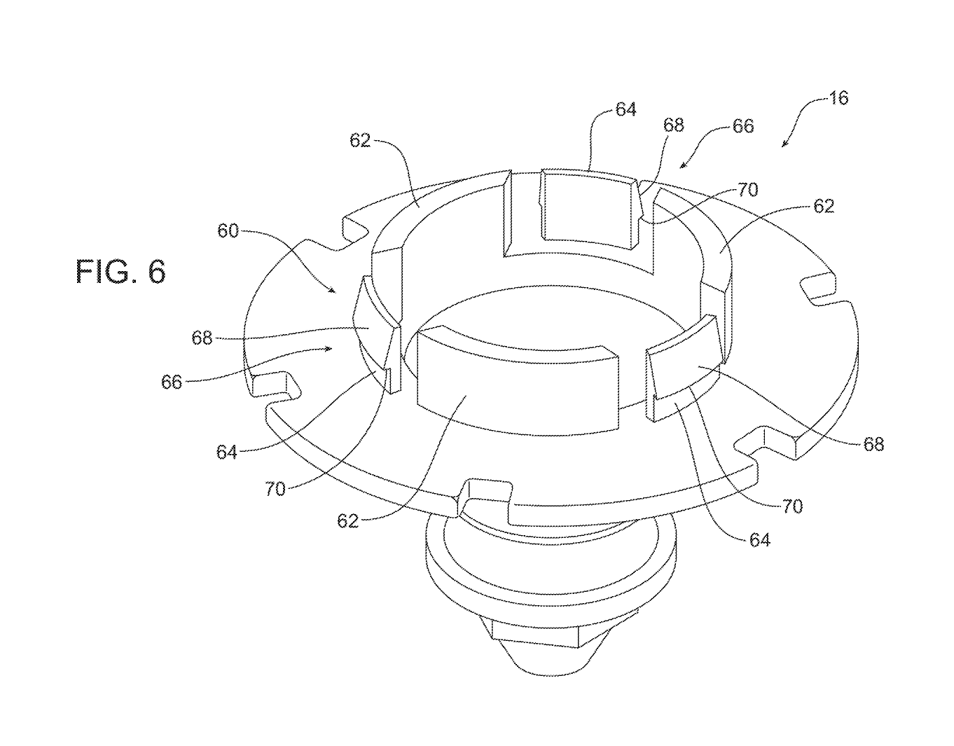

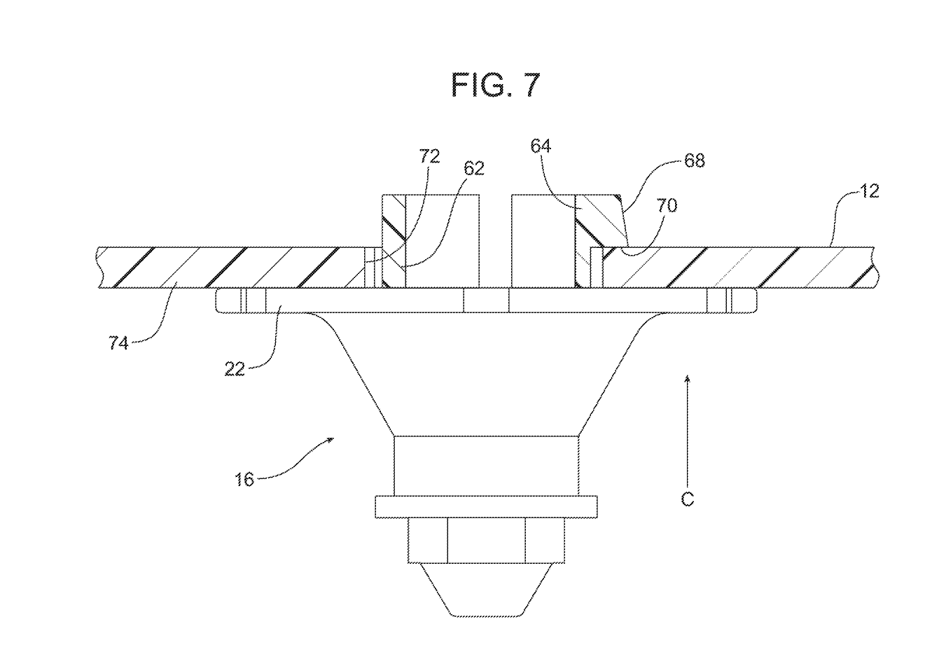

Reference is now made to FIGS. 6 and 7 illustrating an alternative embodiment of discrete mounting feature 16. Whereas the first embodiment of the discrete mounting feature 16 illustrated in FIGS. 1 and 2 included a filter housing mounting side 25 with a twist-lock mounting feature, the alternative embodiment of the discrete mounting feature includes an axial snap mounting feature 60. More particularly, as illustrated, the axial snap mounting feature 60 includes a segmented pilot ring 62 and a plurality of snap tabs 64. In the illustrated embodiment, the discrete mounting feature 16 includes three pilot ring segments 62 and three snap tabs 64 presented in an alternating arrangement. Each snap tab 64 includes a snap feature 66 at the distal end thereof. That snap feature 66 includes a ramp 68 and a locking shoulder 70.

As illustrated in FIG. 7, the discrete mounting feature 16 is secured in the mounting aperture 72 in an air filter housing 12 by pressing directly inward in the direction of the illustrated action arrow C. The ramps 68 allow for the insertion and cause the snap tabs 64 to bend inward. Once the discrete mounting feature 16 is fully inserted into the mounting aperture 72 with the mounting flange 22 against the wall 74 of the air filter housing 12, that wall has cleared the shoulders 70. The resilient snap tabs 64 then snap back by resilient memory so that the shoulders 70 engage the interior face of the wall 74 thereby securing the discrete mounting feature in position on the air filter housing 12.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An apparatus, comprising:
an air filter housing;
a receiver on said air filter housing; and
a discrete mounting feature secured to said air filter housing at said receiver.

2. The apparatus of claim 1, wherein said receiver comprises a filter housing margin surrounding a mounting aperture.

3. The apparatus of claim 2, wherein said receiver includes a plurality of insert notches in communication with said mounting aperture.

4. The apparatus of claim 3, wherein said discrete mounting feature includes a pilot ring received in said mounting aperture.

5. The apparatus of claim 4, wherein said pilot ring includes a plurality of retaining tabs radially arrayed around said pilot ring.

6. The apparatus of claim 5, wherein said filter housing margin includes a plurality of arc segments extending between said plurality of insert notches.

7. The apparatus of claim 6, wherein each arc segment of said plurality of arc segments includes a catch at a first end and a stop at a second end.

8. The apparatus of claim 7, wherein said catch includes a ramp adjacent one insert notch of said plurality of insert notches and a shoulder opposite said ramp oriented toward said stop.

9. The apparatus of claim 8, wherein said discrete mounting feature includes a mounting flange, said mounting flange, said pilot ring and said plurality of retaining tabs defining a plurality of channels receiving said plurality of arc segments when said plurality of retaining tabs are secured in a juxtaposed, overlapping relationship with said plurality of arc segments between said catch and said stop on each said arc segment.

10. The apparatus of claim 9, wherein said discrete mounting feature includes a tapered mounting pin.

11. The apparatus of claim 10, wherein said tapered mounting pin includes an integral drive feature.

12. The apparatus of claim 11, wherein said tapered mounting pin includes a first frustoconical section and a second frustoconical section.

13. The apparatus of claim 12, wherein said tapered mounting pin includes a locking ring.

14. The apparatus of claim 13, wherein said tapered mounting pin includes a cylindrical section.

15. The apparatus of claim 14, wherein said integral drive feature, said locking ring and said cylindrical section are positioned between said first frustoconical section and said second frustoconical section.

16. The apparatus of claim 15, wherein said locking ring is between said cylindrical section and said integral drive feature.

17. The apparatus of claim 16, wherein said integral drive feature includes six facets.

18. The apparatus of claim 16, further including a plurality of integral drive features located on an external circumference of said mounting flange.
